(19) United States
(12) Patent Application Publication
(10) Pub. No.: US 2006/0127740 A1
(43) Pub. Date: Jun. 15, 2006

(54) Oxidant flow system for submerged metal air electrochemical cell

(76) Inventors: William Morris, Danbury, CT (US); Julio G. Solorzano, Peruvian (PE)

Correspondence Address: REVEO, INC., 3 WESTCHESTER PLAZA, ELMSFORD, NY, 10523, US

(21) Appl. No.: 10/532,614

(22) PCT Filed: Oct. 23, 2003
(86) PCT No.: PCT/US03/33811

§ 371 Date: Nov. 23, 2005

Related U.S. Application Data
(60) Provisional application No. 60/420,689, filed on Oct. 23, 2002.

(51) Int. Cl. H01M 8/02; H01M 8/04

(52) U.S. Cl. 429/38; 429/24

(57) ABSTRACT

A system is provided for efficiently and conveniently circulating oxidant (e.g., air) across an air cathode of a sub-merged or partially submerged electrochemical cell. The electrochemical cell includes an air inlet in gaseous communication with a surface of the air cathode. A cathode frame is provided having designated passageways for causing air to flow in a multi directional path across the surface of the air cathode. The cathode frame provides access to an air outlet at a top end of the air cathode. Airflow has a gradient from the inlet to the outlet due to the increased temperature of the air imparted by heat of electrochemical reaction.

### BACKGROUND

Metal air electrochemical cells are desirable energy sources, particularly for features such as relatively high specific energy (W-H/kg). In general, metal electrode materials (anodes) are oxidized by hydroxide ions formed at an air diffusion electrode (cathode).

One particularly desirable configuration of a metal air electrochemical cell is as a sea-water battery. That is, the electrolyte for the electrochemical reactions is provided by sea-water. Common anode materials for these cells include magnesium and magnesium alloys.

It has been attempted to submerge metal air or magnesium air batteries in open waters, e.g., ocean waters, bays, lagoons, etc. A conventional problem associated with submerged metal air electrochemical cells is the limitation of the available oxygen. Typical submerged systems simply use dissolved oxygen within water.

It would be desirable to provide submerged systems with larger flow volumes of reaction oxygen, thus leading to higher current densities as compared to typical submerged electrochemical cell systems. However, no submerged electrochemical cell system exists using ambient air as the oxygen source, as opposed to oxygen dissolved within water.

### SUMMARY

The above-discussed and other problems and deficiencies of the prior art are overcome or alleviated by the several methods and apparatus of the present invention for efficiently and conveniently circulating oxidant (e.g., air) across an air cathode of a submerged or partially submerged electrochemical cell. The electrochemical cell includes an air inlet in gaseous communication with a surface of the air cathode. A cathode frame is provided having designated passageways for causing air to flow in a multi directional path across the surface of the air cathode. The cathode frame provides access to an air outlet at a top end of the air cathode. Airflow has a gradient from the inlet to the outlet due to the increased temperature of the air imparted by heat of electrochemical reaction.

The above-discussed and other features and advantages of the present invention will be appreciated and understood by those skilled in the art from the following detailed description and drawings.

### BRIEF DESCRIPTION OF THE FIGURES

FIG. 1 is a general schematic of a submergible or partially submergible metal air electrochemical cell;

FIG. 2 shows an air cathode frame used for directing air in a preferred airflow pattern; and

FIG. 3 shows an exploded view of air cathode frame;

FIG. 4, shows a side view of a submergible or partially submergible metal air electrochemical cell.

### DETAILED DESCRIPTION

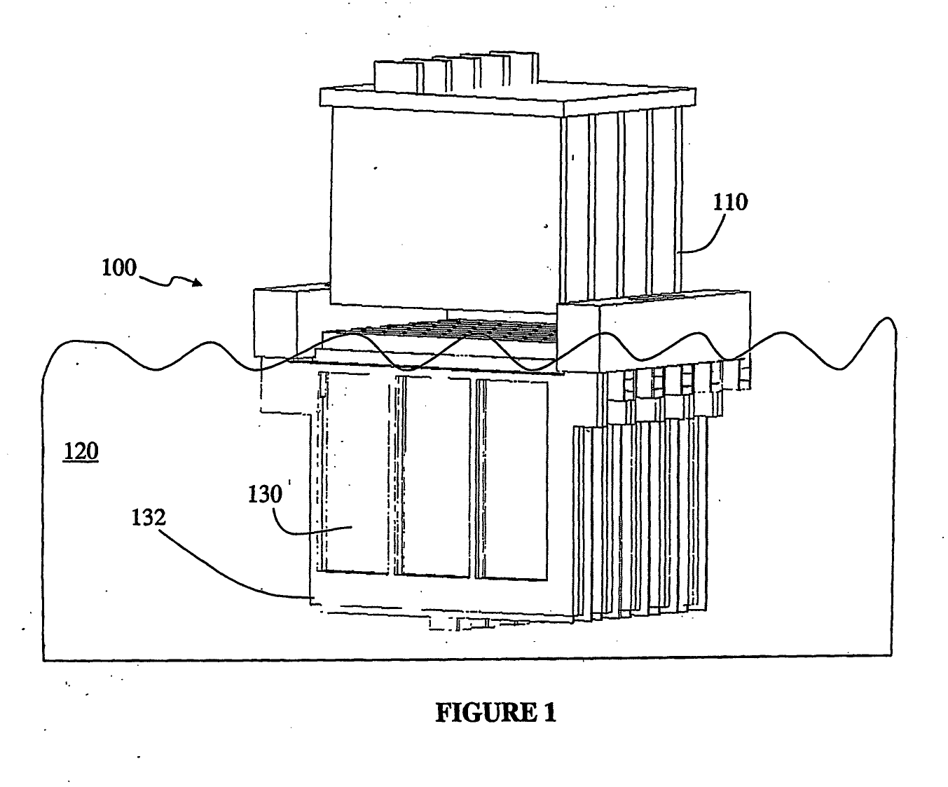

Referring now to FIG. 1, a partially submerged metal air electrochemical cell system 100 is depicted submerged in a body of electrolyte 120. In certain embodiments, the system 100 is a magnesium air system and the cell is submerged in salt water (e.g., a salt water bath, or directly in a body of salt water, such as the ocean). However, in general, the system may be submerged in any other suitable electrolyte compatible with the electrode materials. The system 100 generally includes anodes 110 and corresponding cathodes 130 having a cathode frame 132, as described further herein.

The system may optionally include an internal subsystem for circulating electrolyte. However, in certain embodiments, for example, where there is sufficient turbulence (e.g., waves of the ocean) to transfer electrolyte (e.g., seawater), circulation systems may not be necessary. Such circulation systems may create circulation by establishing an electrolyte flow gradient, e.g., with external or internal pumps. In other embodiments, byproducts of reaction may assist in providing the gradient. For example, in magnesium based systems, it is known that hydrogen evolves from the electrochemical reaction. In certain embodiments, the hydrogen evolution may create the suitable gradient.

As is known in the art of metal air electrochemical cells, the metal anode may comprise suitable oxidizable metals such as magnesium, zinc, aluminum, calcium, lithium, ferrous metals, and combinations and alloys comprising at least one of the foregoing metals. During conversion in the electrochemical process, the metal is generally converted to a metal oxide. The anode may be in the form of a solid metal plate, or a structure of metal particles formed contiguously with suitable binders and the like.

The electrolyte generally comprises ion conducting liquid media. In a preferred embodiment, wherein the cell system is a magnesium air electrochemical cell, a neutral electrolyte such as salt water is used. However, caustic electrolytes may be used, e.g., potassium hydroxide, in zinc air or aluminum air system.

The air cathode may be a conventional air diffusion cathode, for example generally comprising an active constituent and a carbon substrate, along with suitable connecting structures, such as a current collector. The carbon used is preferably chemically inert to the electrochemical cell environment and may be provided in various forms including, but not limited to, carbon flake, graphite, other high surface area carbon materials, or combinations comprising at least one of the foregoing carbon forms. A binder is also typically used in the cathode, which may be any material that adheres substrate materials, the current collector, and the catalyst to form a suitable structure. An exemplary air cathode is disclosed in U.S. Pat. No. 6,368,751, entitled “Electrochemical Electrode For Fuel Cell”, to Wayne Yao and Tsepin Tsai, which is incorporated herein by reference in its entirety. Other air cathodes may instead be used, however, depending on the performance capabilities thereof, as will be obvious to those of skill in the art.

To electrically isolate the anode from the cathode, a separator is generally provided between the electrodes. The separator may be disposed in physical and ionic contact with at least a portion of at least one major surface of the anode, or all major surfaces of the anode, to form an anode assembly. In still further embodiments, the separator is disposed in physical and ionic contact with substantially the surface(s) of the cathode that will be proximate the anode. The physical and ionic contact between the separator and the anode may be accomplished by: direct application of the separator on one or more major surfaces of the anode; enveloping the anode with the separator; use of a frame or other structure for structural support of the anode, wherein the separator is attached to the anode within the frame or other structure; or the separator may be attached to a frame or other structure, wherein the anode is disposed within the frame or other structure.

The separator may be any commercially available separator capable of electrically isolating the anode and the cathode, while allowing sufficient ionic transport between the anode and the cathode, and maintaining mechanical integrity in the cell environment. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator may also comprise additives and/or coatings such as acrylic compounds and the like to make them more wettable and permeable to the electrolyte.

Various materials may be used for the cell frame components, spacers, and other support structures described herein, which are preferably inert to the system chemicals. Such materials include, but not limited to, thermoset, thermoplastic, and rubber materials such as polycarbonate, polypropylene, polyetherimide, polysulfonate, polyethersulfonate, polyarylether ketone, Viton® (commercially available from EI DuPont de Nemours & Co., Wilmington Del.), Delrin® (commercially available from EI DuPont de Nemours & Co., Wilmington Del.), ethylenepropylenediene monomer, ethylenepropylene rubber, and mixtures comprising at least one of the foregoing materials.

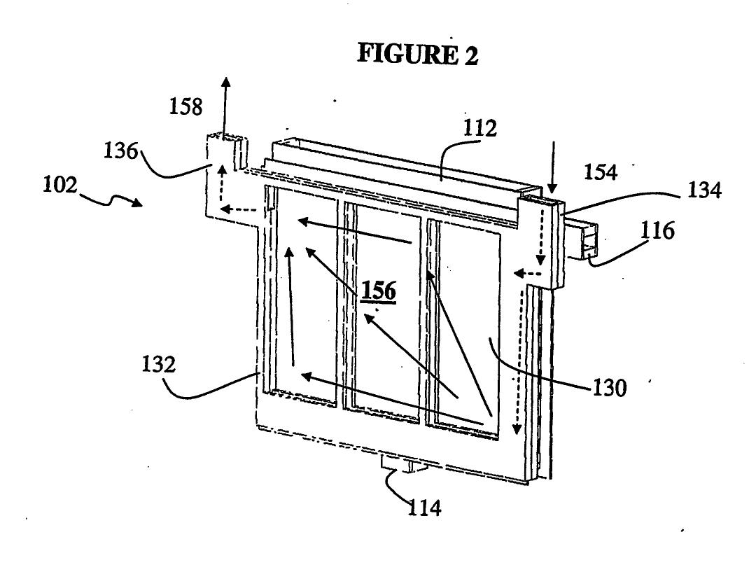

Referring now to FIG. 2, one cell structure 102 of the system 100 is shown, without the anode 110 inserted therein. The cell structure 102 generally includes an air cathode 130 and a cathode frame 132, generally shown adjacent to the face of a cathode 130. However, it is understood that another cathode may be placed over the cathode frame 132, such that a common air path is created for a pair of cathodes 130 separated by cathode frame 132. The cathode frame 132 generally includes an air inlet 134 and an air outlet 136. The air inlet 134 and outlet 136 may be adjusted in length as needed for the particular application. In alternative embodiments, the air inlet 134 and outlet 136 may include adjustable structures, such as telescoping tubes, to allow for air intake and exhaust, e.g., such as snorkels known in the submarine arts. In further alternative embodiments, the air inlet 134 and outlet 136 may be covered with a suitable air permeable membrane suitable to prevent liquid penetration (e.g., formed of hydrophobic materials).

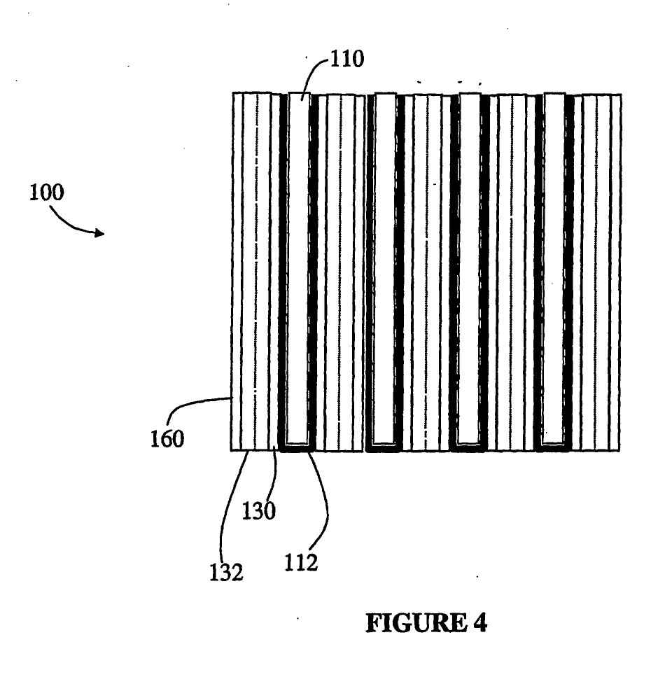

Referring now to FIG. 4, a side view of the system 100 is generally shown, including end plates 160 adjacent the outermost cathode frames 132, cathodes 130, anode receiving structures 112 and anodes 110. These plural structures may be assembled together by various techniques. In certain embodiments, the plural components and frames are formed as in integral system (e.g., with or without the anodes 110 therein) by castings, techniques for assembling plural cells to form a multiple cell system are described in PCT Application Serial No. US03/17356 entitled “Method Of Manufacturing Metal Air Cell System” filed on Jun. 2, 2003, which is incorporated by reference herein. Any suitable method may be used to seal the cell components from the liquid that it is submerged in, of course, with the exception of controlled electrolyte flow paths (e.g., through anode receiving structures 112).

The cell structure 102 further includes an anode receiving structure 112, configured and dimensioned to receive an anode 110. This anode receiving structure 112 may include, for example, separators attached to a frame, the frame being configured and dimensioned to support the an anode 110. The anode receiving structure may include electrolyte passage ports 114, 116, for electrolyte circulation.

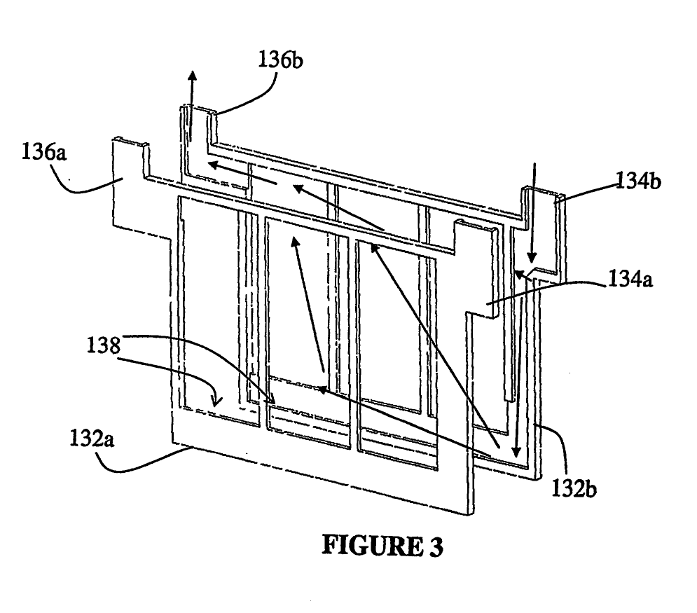

As shown in FIG. 2, oxidant supply 154 (e.g., air from ambient or a dedicated oxidant supply) enters the system via inlet 134. Referring also now to FIG. 3, the cathode frame 132 generally comprises opposing sides 132a and 132b. The inside portions of the flame sides 132a and 132b are configured with cut-away portions to form an airflow channel 138. The airflow channel 138 prevents air from escaping the system other than through inlet 134 and outlet 136, providing a baffle at the bottom of the cell as depicted in the figures. The air flows down generally to the bottom of the frame 132 guided in part by a portion of the channel 138. Proximate the inlet 134, the channel 138 extends from the top down proximate the bottom, leaving an opening for air to pass across the cathode(s). Air circulates across the cathode as indicated by path 156. Optionally several additional frame portions are included for structural support.

As the air flows across the face of the cathode(s) 130, the temperature of the air increases due to the heat of reaction. As is well known, the tendency of increased temperature air is to rise; therefore, the convection of the airflow will cause exhaust air 158 to exit the system via outlet 136. The hotter, oxygen depleted air rises through the outlet 136 (at top of cell), which creates a suction drawing fresh, cooler air in through the inlet 134 (at the bottom of the cell). Alternatively, secondary driving forces may be included to provide an air flow gradient. For example, suitable air pumps or fans may be incorporated in the system, i.e., in the path of inlet 134.

While preferred embodiments have been shown and described, various modifications and substitutions may be made thereto without departing from the spirit and scope of the invention. Accordingly, it is to be understood that the present invention has been described by way of illustrations and not limitation.

1. An electrochemical cell system comprising:
at least one cell having
an anode and at least one air cathode in ionic communication and electrical isolation, and
a cathode frame adjacent the air cathode, the cathode frame including an oxidant inlet and an oxidant outlet,
wherein the oxidant inlet and oxidant outlet are configured and dimensioned such that upon submergence of the at least one cell in a body of liquid, oxidant flow between the inlet and outlet is not prevented from accessing the air cathode by the liquid.

2. The electrochemical cell system as in claim 1, wherein each anode has a first surface and a second surface, further wherein a first air cathode portion is electrochemically coupled to the first surface of the anode and a second air cathode portion is electrochemically coupled to the second surface of the anode.

3. The electrochemical cell system as in claim 2, comprising at least a first cell and a second cell, wherein a single cathode frame is provided between air cathode portions of adjacent cells.

4. The electrochemical cell system as in claim 1, wherein a driving force for air flow is created upon discharge of the electrochemical cell due to the increased temperature of the air imparted by heat of electrochemical reaction.

5. The electrochemical cell system as in claim 1, further comprising a source of an external driving force for air flow.
